(19) United States
(12) Patent Application Publication
(10) Pub. No.: US 2014/0326438 A1
(43) Pub. Date: Nov. 6, 2014

(54) INTERNAL HEAT EXCHANGER FOR A MOTOR VEHICLE AIR CONDITIONING SYSTEM

(71) Applicant: GM GLOBAL TECHNOLOGY OPERATIONS LLC, Detroit, MI (US)

(72) Inventors: Artem Seryi, Wiesbaden (DE); Lothar Seybold, Nauheim (DE)

(73) Assignee: GM GLOBAL TECHNOLOGY OPERATIONS LLC, Detroit, MI (US)

(21) Appl. No.: 14/268,902

(22) Filed: May 2, 2014

(30) Foreign Application Priority Data
May 2, 2013 (DE) 102013007590.4

(51) Int. Cl. F28D 7/10; B23P 15/26

(52) U.S. Cl. CPC F28D 7/10; B23P 15/26
USPC 165/154; 29/890.036

(57) ABSTRACT

A heat exchanger for a motor vehicle air-conditioning system is disclosed having an inner tube and with an outer tube. The outer tube at least partially encloses the inner tube in the longitudinal direction of the tube and form an intermediate space through which a heat exchanger medium can flow. Radially extending web at least partially divided the intermediate space into multiple flow channels between the inner tube and the outer tube. The multiple flow channels open in the longitudinal direction into a distributor or collector space formed through a radial tapering of the inner tube.

### CROSS REFERENCE TO RELATED APPLICATION

This application claims priority to German Patent Application No. 102013007590.4 filed May 2, 2013, which is incorporated herein by reference in its entirety.

### TECHNICAL FIELD

The technical field relates to a heat exchanger. The heat exchanger for a motor vehicle air-conditioning system, which in particular is designed as an internal heat exchanger for increasing the efficiency of the air-conditioning system.

### BACKGROUND

To increase the performance and efficiency of motor vehicle air-conditioning systems, so-called internal heat exchangers (IHX) are known, which thermally couple a portion of the refrigerant circuit running between evaporator and compressor to a portion of the refrigerant circuit running between condenser and expansion valve. In this way, the comparatively cold refrigerant flowing from the evaporator to the compressor can be employed for (pre) cooling or sub-cooling of the comparatively warm refrigerant fed in to the expansion device on the high-pressure side of the refrigerant circuit.

For optimizing the mode of operation of such heat exchangers in the refrigerant circuit, the geometrical dimensions and shapes of the tubes are important. In an existing vehicle package, which has limited ability for individually adapting or changing the outer contour or outer geometry of the heat exchanger, it is comparatively difficult to adapt such heat exchangers with respect to their heat exchanger capacity to predetermined requirements, for example for vehicle specific applications.

Internal heat exchangers can furthermore be designed as coaxial tube heat exchangers. Here, at least one inner tube is completely enclosed in circumferential direction by an outer tube. In the inner space of the inner tube and in the intermediate space between inner tube and outer tube an exchange of thermal energy can then take place between the heat exchanger medium flowing in the opposite flow direction in each case. For connecting coaxial tube heat exchangers into the refrigerant circuit of an air-conditioning system it is required to pass the inner tube through the outer tube or provide a suitable connection for the outer tube surrounding the inner tube.

Thus, EP 1 101 638 A1 for example describes a tube arrangement with at least one connector. Here, the connector has a cylindrical shape with a cavity and a first passage through a first longitudinal end. Here, the inner tube extends through the first passage and through the cavity. The connector furthermore contains a radially expanded opening at an end of the cavity in order to receive an outer tube. Here, the outer tube is connected to the connector via a press fit.

On the one hand, providing a separate connector increases the component number for an internal heat exchanger. On the other hand, the production and assembly process for such connection solutions proves to be comparatively complex. Since the tubes during the operation of the heat exchanger later on are subjected to a pressurized heat exchanger medium a fluid-tight, pressure-stable and durable connection of the individual components is to be guaranteed.

In this regard, there is a need to provide an improved internal heat exchanger for a motor vehicle air-conditioning system, which can be produced in a particularly efficient, cost-effective and simple manner. Furthermore, the heat exchanger should be characterized by a reduction in components and by a possible weight minimization and a long lifespan as well as a good thermal load capacity.

### SUMMARY

Accordingly, a heat exchanger for a motor vehicle air-conditioning system is disclosed herein. The heat exchanger includes an inner tube and an outer tube, wherein the outer tube encloses the inner tube at least partially in a longitudinal direction (z) relative to the tube subject to forming an intermediate space through which a heat exchanger medium can flow. That intermediate space which is formed approximately annularly between inner tube and outer tube is at least partially subdivided into multiple flow channels by means of webs radially extending between the inner tube and the outer tube. Here, the flow channels open in tube longitudinal direction into a distributor or collector space formed through a radial tapering of the inner tube.

Typically, at least three webs which are approximately equidistantly spaced from one another in tube circumferential direction are provided, which subdivide the intermediate space between inner tube and outer tube into multiple, and preferably at least three, flow channels running parallel to one another in tube longitudinal direction, through which heat exchanger medium can flow in tube longitudinal direction. Inner tube and outer tube are arranged in particular coaxially to one another, wherein the center point of the inner tube coincides with the center point of the outer tube.

Inner tube and outer tube are typically cylindrical, i.e. formed circular in cross section, so that the intermediate spaced formed between inner tube and outer tube, viewed in circumferential direction, has a constant radial extension. By way of the webs subdividing the intermediate space into multiple flow channels, inner tube and outer tube can support themselves on one another. The webs in this regard also provide a mutual radial fixing of inner tube and outer tube.

Since the flow channels of the intermediate space typically running parallel to one another are separated from one another through the radial webs, at least one distributor or collector space for the feeding and discharging the heat exchanger medium to and from the individual flow channels is provided. Each distributor is in flow connection with all flow channels of the intermediate space adjoining thereon in tube longitudinal direction. Here, the distributor or collector space is a radial taper of the inner tube, so that an approximately annular free space between the radially tapered outer surface of the inner tube and the inner surface of the outer tube is obtained in the region of the radial taper.

The radial taper of the inner tube in this case comes to lie spaced from the webs provided on the inside of the outer tube, so that via the distributor or collector space approximately extending annularly about the outer circumference of the inner tube a flow connection of all flow channels extending hereon in tube longitudinal direction can materialize.

Typically, the inner tube includes two radial tapers spaced from one another in tube longitudinal direction, of which one acts as a distributor space and the other as a collector space for the fed-in heat exchanger medium. The radial taper formed on or in the inner tube in this regard makes possible a flow circulation about the inner tube in circumferential direction and thus a distribution of the heat exchanger medium fed into the distributor space over the adjoining flow channels of the intermediate space. The collector space formed accordingly, and for example provided, on the other end of the inner tube can provide a collector function through its flow or fluid connection to all flow channels, so that the heat exchanger medium flowing via all flow channels can be collected in the collector space and from there be transferred in a quasi-bundled manner through the housing of the heat exchanger into the refrigerant circuit of the motor vehicle air-conditioning system.

Because the distributor or collector space is formed through a radial tapering of the inner tube, end caps for such heat exchangers to be connected to the inner and/or outer tube that were provided in the past are no longer required. The distributor or collector space integrated in the inner tube in this regard makes possible a part and component reduction of the heat exchanger. In this respect, the latter can be produced with material and weight saving and particularly production-rationally. In particular, by omitting an end cap a corresponding connecting point between end cap and inner or outer tube can be omitted. Furthermore, through the omission of such connecting points a particularly robust and less fault-susceptible heat exchanger can be provided.

According to a further configuration, the distributor or collector space is formed through an annular depression in the outer surface of the inner tube running in circumferential direction (u). Here it is provided in particular that the radial tapering of the inner tube is formed closed in circumferential direction and accordingly completely encloses the outer surface of the inner tube. In this way, not only all flow channels adjoining thereon in axial or in tube longitudinal direction can be brought into flow connection with the annular depression but the annular depression completely enclosing the outer circumference of the inner tube furthermore proves to be advantageous also for the feeding and discharging of the heat exchanger medium to be distributed or collected in a flow-related respect.

According to a further configuration, the annular depression has a bottom portion formed level, which via at least one portion running obliquely to the tube longitudinal direction merges into the outer surface of a line portion of the inner tube adjoining hereon in tube longitudinal direction. The line portion of the inner tube is characterized in that it supports itself on the inner wall of the outer tube via the webs provided in the intermediate space and in this regard forms a radial boundary for the flow channels provided in the intermediate space. The line portion of the inner tube merges into the annular depression in the region of the distributor or collector space. The ramp portion extending obliquely between the annular depression and the line portion which with respect to the former is radially expanded proves to be advantageous in a flow-related respect for the distributing or collecting of the heat exchanger medium.

Here it can be provided furthermore that the annular depression on end portions which are located opposite in tube longitudinal direction in each case with respect to the tube longitudinal direction has ramp portions which are formed symmetrically to one another.

According to a further development, the outer tube is radially penetrated by an inflow or outflow of the heat exchanger adjoining the distributor or collector space. The inflow or outflow in this case is in flow connection with the distributor or collector space.

Upon configuration of a distributor space, the outer tube portion radially adjoining hereon is penetrated by an inflow while upon configuration of a collector space an outflow is accordingly provided on the outer tube. Based on the longitudinal or axial extension of the annular depression, the inflow or outflow can be arranged approximately centrally with respect to the distributor or collector space. However it is also conceivable and by all means advantageous for the distributing or collecting of the heat exchanger medium when the inflow or outflow, with respect to the intended flow direction, is arranged at least slightly upstream of the geometrical axial center of the distributor or collector space. In this way, almost the entire longitudinal or axial extension of the distributor or collector space can be utilized for as homogenous and uniform a distribution of the heat exchanger medium over the individual flow channels or for a collecting of the individual flow channels.

According to a further configuration, the flow channel-forming webs are arranged on the inside of the outer tube. In the region of the distributor or collector space, these can extend in tube longitudinal direction beyond the distributor or collector space. Such a configuration is advantageous in particular in the case of a one-piece design of webs and outer tube, since for forming the distributor or collector space for example an extruded outer tube provided with webs can be employed directly as a heat exchanger outer tube without any rework to speak of.

According to a further configuration, the depth of the radial tapering or the radial extension of the annular depression compared with the outer surface or the line portion is approximately 10% to 25% of the cross-sectional radius of the inner tube. Thus, the diameter of the bottom portion of the annular depression can likewise be formed approximately 10% to 25% smaller than the outer diameter of the inner tube. With typical heat exchanger geometries, the annular depression can have a radial depth of 1.0 mm to 1.5 mm, so that through the annular depression a diameter reduction of the inner tube of 2 mm to 3 mm can be formed in total.

The radial extension of the webs is typically smaller than the radial extension or the radial depth of the taper of the inner tube. The radial depth of the annular depression can in particular amount to 1 to 5 times the radial extension of the webs. Typical radial web heights are approximately in the range from 0.2 mm to 1 mm, preferentially between 0.4 mm to 0.8 mm or also between 0.2 mm to 0.4 mm.

According to a further configuration, the inner tube projects from at least one axial end portion of the outer tube in tube longitudinal direction. Here, the end portion of the outer tube is connected to an outer wall portion of the inner tube. Typically, the axial end portion of the inner tube projects from the axial end portion of the outer tube by a predetermined dimension, wherein the end face of the outer tube can be connected to an outer wall portion of the inner tube. However, it is also conceivable that the inside of the outer tube is connected to the outer wall portion of the inner tube directly coming into contact hereon.

The outer tube is completely connected with its end portion in particular in circumferential direction to the inner tube, so that the intermediate space ends with the connection of inner tube and outer tube. Here it can be provided in particular that both axial end portions of the outer tube located opposite are axially penetrated by the inner tube and that the respective axial end portions of the outer tube are connected to the outer wall of the inner tube. In this way, a through-passage of the inner tube through the outer tube can be formed, so that providing separate end caps for the heat exchanger can be advantageously omitted.

According to a further configuration, the end portion of the outer tube is connected to the inner tube in a materially joined and/or frictionally joined manner. It can be provided in particular that the outer tube is connected to the inner tube through soldering or welding. Additionally or alternatively to this however an at least regional deformation of the outer tube, in particular a crimping of the outer tube which is radially directed to the inside can also be provided, as a result of which the outer tube can be connected to the inner tube in a frictionally joined manner. accompanying such a frictionally joined connection and in particular for reasons of adequate tightness, the axial end of the outer tube can be circumferentially soldered or welded to the outer wall portion of the inner tube.

In particular with a crimped or frictionally joined connection of outer tube and inner tube it can be provided according to a further configuration that the axial end portion of the outer tube is designed radially tapered relative to an adjoining line portion of the outer tube. The inner tube penetrates the radially tapered end portion of the outer tube typically in a fluid and/or gas-tight manner.

The radial tapering can be effected in particular after insertion of the inner tube into the outer tube. In this regard, the outer tube can be pressed radially directed to the inside following intended insertion of the inner tube, as a result of which adequate mechanical fixing of inner tube and outer tube can already be provided.

According to a further configuration, the outer tube and the inner tube are formed as a high-pressure line and a low-pressure line respectively. An inflow for the intermediate space in this case can be arranged downstream of a condenser, an outflow of the intermediate space can be arranged upstream of an expansion device, an inflow for the inner tube can be arranged downstream of an evaporator and an outflow of the inner tube can be arranged upstream of a compressor in the refrigerant circuit of a motor vehicle air-conditioning system.

While outflow and inflow for the inner tube can be directly connected to corresponding components of the motor vehicle air-conditioning system in a fluid-conducting manner, the outflow and the inflow for the intermediate space of the heat exchanger are each provided in the region of the distributor or collector space. Here, inflow and outflow can penetrate the outer tube at the height of the distributor or collector portion approximately in radial direction, or adjoin the outer tube. Outflow and inflow for the distributor or collector space in this case can be connected as connection piece to the radially expanded distributor or collector portion of the outer tube and connected herewith in a fluid-tight manner.

It is generally true in this case that the low-pressure lines are designed for the flow-related coupling of evaporator and compressor, the high-pressure lines by contrast for the flow-related coupling of condenser and expansion device of the refrigerant circuit of the air-conditioning system and can accordingly be connected to the mentioned components of the air-conditioning system in a fluid-conducting manner.

During the operation of the heat exchanger or during the operation of the air-conditioning system, the inner tube of the heat exchanger is predominantly subjected to a through-flow of a gaseous heat exchanger medium, while the outer tube or the intermediate space formed by inner tube and outer tube and subdivided into individual flow channels by webs can be subjected to a through-flow of a predominantly compressed fluid.

The inner tube and the intermediate space between inner tube and outer tube in this case can be preferably subjected to a through-flow according to the counter-flow principle, which makes possible an improved heat exchange compared with the parallel flow principle.

According to a further independent aspect, a motor vehicle air-conditioning system with a refrigerant circuit is finally provided, which couples at least one compressor, one condenser, one expansion device and one evaporator to one another in a flow-related manner for circulating a heat exchanger medium. Here, the refrigerant circuit furthermore includes a previously described heat exchanger, the intermediate space of which is incorporated in a flow-related manner between condenser and expansion device and the inner tube of which is incorporated between evaporator and compressor of the refrigerant circuit in a flow-related manner.

In this way, a heat exchange serving for the increase of the performance and efficiency of the air-conditioning system between the low-pressure side located downstream of the evaporator and the high-pressure side located upstream of the expansion device of the refrigerant circuit can be provided.

In a further independent aspect, a motor vehicle with a previously described air-conditioning system or with at least one previously described heat exchanger which is for example designed coaxially and tubularly is provided.

Furthermore, a method for producing a previously described heat exchanger is provided. Here, the method includes the steps: (i)providing an outer tube provided with webs radially projecting to the inside;(ii) providing and regional radial tapering of an inner tube for forming a distributor or collector space; (iii) inserting the inner tube into the outer tube; and (iv) connecting inner tube and outer tube.

Here it is provided in particular that the outer tube in the region of the radial tapering of the inner tube is provided with a connection piece formed as an outlet or as an inlet, which radially penetrates the outer tube and via which the heat exchanger medium can be conducted into the intermediate space formed by outer tube and inner tube or discharged out of said intermediate space.

In that the distributor or collector space is formed through radial tapering, for example through suitable deforming or stamping of the inner tube, the webs which are provided in particular on the inside of the outer tube and radially project to the inside can run in tube longitudinal direction over that distributor or collector space. No cutting or forming of the webs is mandatorily required through the radial tapering of the inner tube and can be advantageously omitted.

According to a further configuration it is provided furthermore in this case that the inner tube protrudes from an axial end portion of the outer tube in tube longitudinal direction. The end portion of the outer tube is then connected to an outer wall portion of the inner tube in a materially joined and/or frictionally joined manner. For a materially joined and in this regard fluid-tight connecting of inner tube, soldering or welding of outer tube and inner tube which is complete and continuous in particular in circumferential direction is possible.

A frictionally joined fixing or connecting of inner tube and outer tube can also take place according to a further configuration through a deformation of the outer tube which is directed radially to the inside after a joining of inner tube and outer tube. Here, the outer tube in particular can be pressed together with the inner tube, wherein a mechanical fixing of inner tube and outer tube can already be achieved even by such a pressing together or crimping of the outer tube. The webs which are radially directed to the inside on the outer tube can be subjected to a corresponding forming during the course of the forming of the outer tube and at least partially enter the outer surface of the inner tube.

Depending on the size of the radial web extension, a pressing together or crimping of the outer tube can be required prior to a materially joined connecting of outer tube end portion and inner tube. In particular when the radial web height is to be more than 0.4 mm, a pressing together of outer tube and inner tube prior to a materially joined connecting of outer tube end and inner tube proves to be advantageous. Should the web extension amount to 0.8 mm or more, it can prove to be advantageous furthermore to remove or form the webs in that axial end portion of the outer tube, for example prior to inserting the inner tube into the outer tube at least partially or in portions, so that the webs which are formed comparatively high do not impair a fluid-tight connection of inner tube and outer tube.

### BRIEF DESCRIPTION OF THE DRAWINGS

The present disclosure will hereinafter be described in conjunction with the following drawing figures, wherein like numerals denote like elements, and:

FIG. 1 is a schematic representation of a motor vehicle air-conditioning system;

FIG. 2 is a cross section through an end of the internal heat exchanger according to a first configuration;

FIG. 3 is a cross section through a heat exchanger according to a further configuration;

FIG. 4 is a cross section through the heat exchanger along A-A according to FIG. 2; and

FIG. 5 is a block diagram of a production method for producing the heat exchanger.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

The motor vehicle air-conditioning system 20 schematically shown in FIG. 1 includes a refrigerant circuit 22, which couples the individual air-conditioning system components compressor 18, condenser 16, an expansion device 12 as well as an evaporator 14 in a manner known per se in a fluid-related manner to one another. Here, an internal heat exchanger 10 is arranged on the high-pressure side downstream of the condenser 16 and upstream of the expansion device 12. On the low-pressure side, the internal heat exchanger 10 is provided downstream of the evaporator 14 as well as upstream of the compressor 18.

A heat exchanger medium which is under a comparatively high pressure and high temperature is sub-cooled upstream of the expansion device 12 through the heat exchanger medium which flows in the heat exchanger 10 in opposite direction from the evaporator 14 to the compressor 18 and is under comparatively low pressure and low temperature. Through this internal heat exchanger in the refrigerant circuit 22, the efficiency of the motor vehicle air-conditioning system 20 as a whole can be improved.

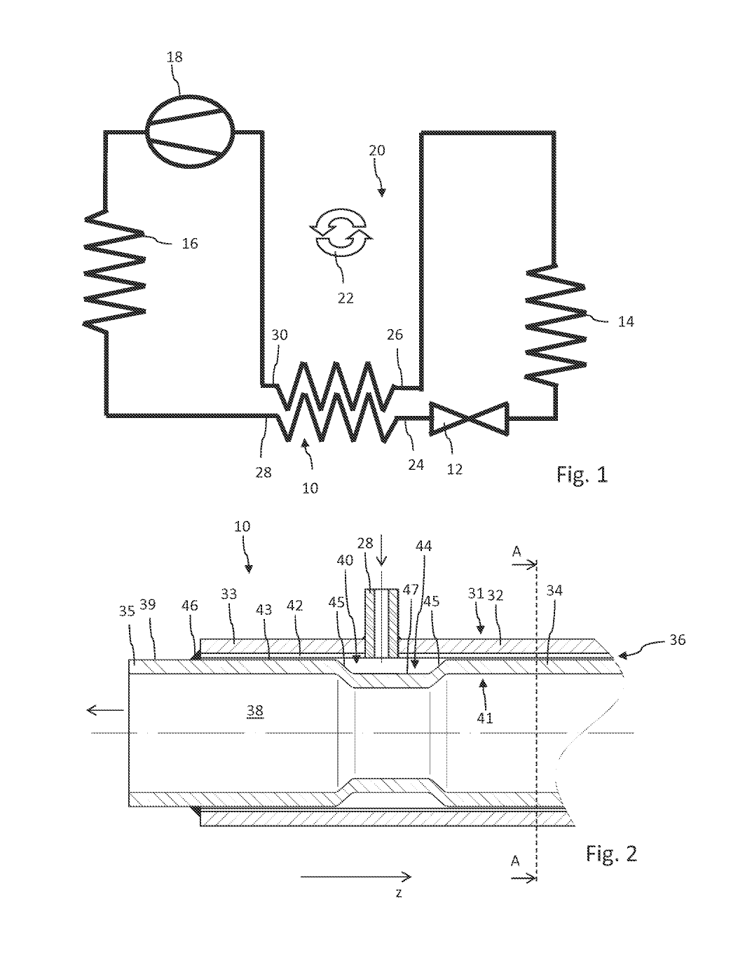

According to the representations in accordance with FIGS. 2-4, the internal heat exchanger 10 provided here has an approximately cylindrical outer tube 32 and an inner tube 34 arranged within the outer tube 34 and preferably coaxially thereto. The inner tube 34 in this case is formed as a low-pressure line and can be incorporated in the refrigerant circuit 22 of the air-conditioning system 20 via an inflow 26 downstream of the evaporator 14 and via an outflow 30 upstream of the compressor 18. In this respect, the inner space 38 of the inner tube 34 can be predominantly subjected to a through-flow of a gaseous heat exchanger medium and/or which is under a comparatively low pressure.

The heat exchanger 10 which is formed tubularly and preferably coaxially with inner tube 34 and outer tube 32 includes multiple webs 42 which are arranged in circumferential direction approximately equidistantly to one another and each extend in axial direction and radial direction, by means of which inner tube 34 and outer tube 32 mutually support themselves on one another in radial direction. The individual webs 42 subdivide the intermediate space 36 which is approximately formed annularly between inner tube 34 and outer tube 32 into individual flow channels 37, which because of the webs 42 do not have any direct flow connection in circumferential direction (u) to one another.

In particular for the feeding and discharging of a heat exchanger medium which is not shown separately, the inner tube 34 includes a distributor or collector space 40 which is formed through a radial taper. The distributor or collector space 40 in this case is formed through an annular depression 44 of the inner tube 34 which is radially directed to the inside. The longitudinal cross section shown in FIG. 2 through that depression 44 has a trapezium-like contour with a bottom portion 47 which is substantially formed level and inclines or ramps 45 adjoining hereon, via which the depression 44 merges into the outer surface 43 of a line portion 41 of the inner tube 34 adjoining hereon in tube longitudinal direction (z).

The radial depth of the depression 44, i.e. the radial spacing of the bottom portion 47 from the outer surface 43 of the inner tube 34 is at least as large as the radial extension of the webs 42. The radial extension of the depression 44 however can also be formed far larger than the radial extension of the webs 42. A configuration of the annular depression 44 which is comparatively deep compared with the web height allows that the webs 42 which are radially directed to the inside and are typically formed in one piece with the outer tube 32 can also be provided in the region of the distributor or collector space 40.

During the configuration of a distributor space 40 through the flow-related connection with all flow channels 37 provided downstream, the annular depression 44 serves for as uniform as possible a distribution of the heat exchanger medium fed in via the inflow 28. As shown in FIG. 2, the inflow 28 in the form of a connector penetrates the outer tube 32 in the region of the distributor space 40 formed through the depression 44. As is indicated furthermore in FIG. 2, the position of the inflow 28 in this case is slightly offset towards the left compared with the axial center of the radial depression 44.

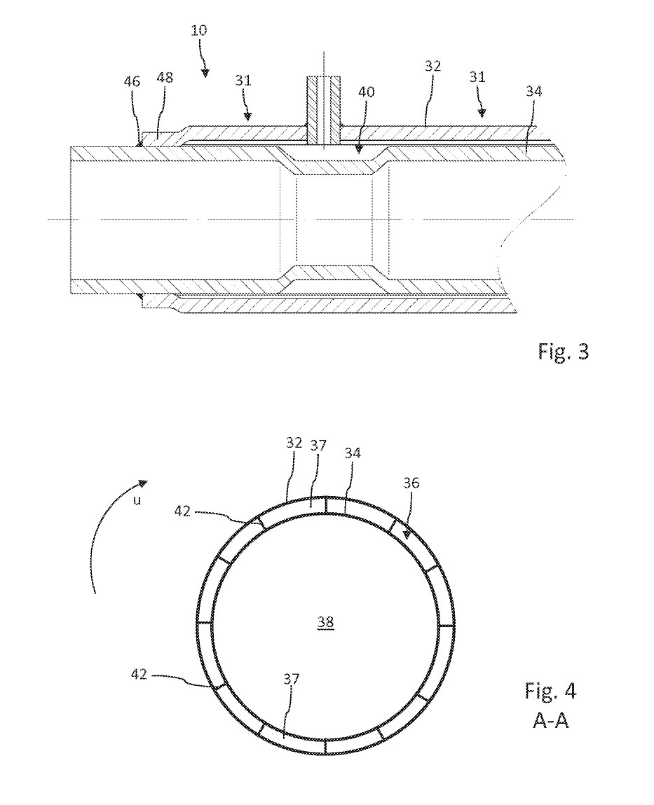

In this regard, the inflow 28 is arranged offset in upstream direction relative to the geometrical axial center of the distributor space 40, so that the heat exchanger medium fed in via the inflow 28 can exploit as completely as possible the axial extension of the distributor space 40 for the preferably uniform supplying of the channels 37 adjoining hereon downstream. As is additionally shown in FIG. 2, the outer tube 32 is penetrated by the inner tube 34 in axial direction (z). An axial end portion 35 of the inner tube 34 thus protrudes from an axial end portion 33 of the outer tube 32 in tube longitudinal direction. As is indicated furthermore in FIG. 2, the end face of the outer tube end portion 33 can be continuously connected in a materially joined manner in circumferential direction to the outer surface or to an outer wall portion 29 of the inner tube 34. In FIGS. 2 and 3, soldered, brazed or welded seams 46 are shown in cross section.

As a function of the radial extension of the webs 42 formed between the outer tube 32 and the inner tube 34, a mere soldering of the outer tube end portion 33 to the outer wall portion 39 of the inner tube 34 can already be adequate for a mechanically sufficiently stable connection of inner tube 34 and outer tube 32. However, if the webs 42 exceed a certain radial extension, for example when the radial web height is larger than 0.4 mm, a pressing together or crimping of the end portion 33 of the outer tube 32 can be advantageous or even necessary for the mutual connecting of outer tube 32 and inner tube 34.

Such a deformation, which opens into a deformation portion 48 of the end portion 33 of the outer tube 32 directed radially to the inside is shown for example in FIG. 3. Such a circumferential pressing together or crimping of the outer tube 32 radially directed to the inside can likewise be adequate for forming a mutual connection of outer tube 32 and inner tube 34. For a fluid-tight configuration, the deformation portion 48 can be complementarily soldered or welded to the outer wall portion 39 of the inner tube 34.

The deformation portion 48 radially directed to the inside or the axial end portion 33 of the outer tube 32 is formed radially tapered compared with a line portion 31 of the outer tube adjoining hereon in the configuration according to FIG. 3. The deformation portion 48 which in this regard is radially pressed or crimped to the inside is arranged in particular axially spaced from the distributor or collector space 40. However, configurations are also conceivable in which the deformation portion 48 of the end portion 33 of the outer tube 32 radially directed to the inside is arranged directly adjoining but not overlapping the annular depression 44 of the inner tube 34.

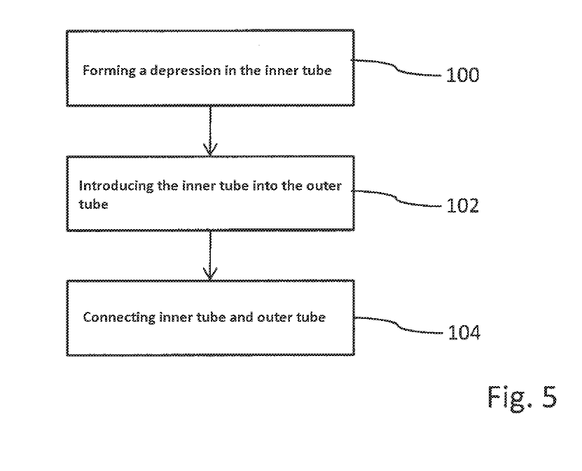

In FIG. 5, a flow diagram illustrates the production method for the heat exchanger 10. Following the provision of an outer tube 32 provided with webs 42 directed radially to the inside a depression which is radially directed to the inside or a radial tapering in the outer surface of the inner tube 34 is introduced in a first step 100. Following the introduction of a preferably annular depression 44 completely enclosing the outer circumference of the inner tube 34, the inner tube 34 is introduced into the outer tube 32 in a following step 102. In a final method step 104 the inner tube 34 is connected to the outer tube 32. Here, a materially joined, for example through soldering, brazing or welding, and/or frictionally joined connection, for example through pressing together or crimping, is provided in particular. Before introducing the inner tube 34 into the outer tube 32, the outer tube 34 can be provided in places provided for this purpose with a connector acting as inflow 28 or as outflow 30 projecting radially to the outside and in each case radially penetrating the outer tube 32, which connector on reaching a final assembly configuration, as shown in FIG. 2, comes to lie in the region of the radial taper of the inner tube 32.

The above-described embodiments merely show possible configurations of the present disclosure to which numerous further revisions are conceivable and within the scope of the present disclosure. The exemplary embodiments should in no way be interpreted as being restrictive with respect to the scope, the applicability or the configuration possibilities of the present disclosure. The present disclosure merely shows the person skilled in the art a possible implementation of an exemplary embodiment of the present disclosure. Thus, a wide range of modifications can be performed in the function and arrangement of described elements without leaving the scope of protection defined through the following patent claims or its equivalent.

1-13. (canceled)

14. A heat exchanger for a motor vehicle air-conditioning system comprising:
an inner tube; and
an outer tube at least partially enclosing the inner tube to form an intermediate space through which a heat exchanger medium is configured to flow in longitudinal tube direction (z);
a web structure radially extending between the inner tube and the outer tube such that at least a portion of the intermediate space is subdivided into a plurality of flow channels which in the longitudinal tube direction open into a radial space formed by a local taper of the inner tube.

15. The heat exchanger according to claim 14, wherein the radial space is an annular depression in an outer surface of the inner tube running in circumferential direction (u).

16. The heat exchanger according to claim 15, wherein the annular depression has a floor portion, a ramp portion running obliquely to the floor portion in the longitudinal tube direction and merges into an outer surface of the inner tube.

17. The heat exchanger according to claim 14, wherein the outer tube adjoining the radial space is radially penetrated by a radial tube having a passage in flow connection with the radial space.

18. The heat exchanger according to claim 14, wherein the web structure extends radially from an inner wall of the outer tube and extends longitudinally beyond the radial space.

19. The heat exchanger according to claim 14, wherein the inner tube protrudes from at least one axial portion of the outer tube in the longitudinal tube direction, and wherein the axial portion of the outer tube is connected to an outer wall portion of the inner tube.

20. The heat exchanger according to claim 19, wherein the axial portion of the outer tube is connected to the inner tube in a materially joined manner.

21. The heat exchanger according to claim 19, wherein the axial portion of the outer tube is connected to the inner tube in a frictionally joined manner.

22. The heat exchanger according to claim 19, wherein the axial portion of the outer tube is formed radially tapered relative to an adjoining line portion of the inner tube.

23. A heat exchanger for a motor vehicle air-conditioning system comprising:
a low-pressure inner tube; and
a high-pressure outer tube at least partially enclosing the low-pressure inner tube to form an intermediate space through which a heat exchanger medium is configured to flow in longitudinal tube direction (z); and
a web structure radially extending between the inner tube and the outer tube such that at least a portion of the intermediate space is subdivided into a plurality of flow channels which in the longitudinal tube direction open into a radial space formed by a local taper of the inner tube;
wherein a first inlet for the intermediate space is configured downstream of a condenser an first outlet from the intermediate space is configured upstream of an expansion device, a second inlet for the inner tube is configured downstream of an evaporator and a second outlet of the inner tube is configured upstream of a compressor in a refrigerant circuit of a motor vehicle air-conditioning system.

24. The heat exchanger of claim 23 in combination with a motor vehicle air-conditioning system comprising a refrigerant circuit having at least one compressor, a condenser, an expansion device and an evaporator in a fluid-related manner with one another for circulating a heat exchanger medium.

25. A method for producing a heat exchanger comprising:
providing an outer tube having a web structure radially projecting from an inner surface thereof;
introducing an inner tube into the outer tube, wherein the inner tube has a partial radial tapering for forming an intermediate space; and
connecting the inner tube and the outer tube such that at least a portion of the intermediate space is subdivided into a plurality of flow channels which in the longitudinal tube direction open into a radial space formed by a local taper of the inner tube.

26. The method according to claim 25, wherein introducing the inner tube into the outer tube such that the inner tube protrudes from an axial portion of the outer tube in a longitudinal tube direction (z), and materially joining the axial portion of the outer tube is connected to an outer wall portion of the inner tube.

27. The method according to claim 25, wherein introducing the inner tube into the outer tube such that the inner tube protrudes from an axial portion of the outer tube in a longitudinal tube direction (z), and frictionally joining the axial portion of the outer tube is connected to an outer wall portion of the inner tube.

28. The method according to claim 25, further comprising radially deforming the axial portion of the outer tube inwardly for connecting to the inner tube.

29. The method according to claim 25, further comprising reducing the web structure in a radially inward direction prior to a connecting the inner tube and the outer tube.
